(19) United States
(12) Patent Application Publication
(10) Pub. No.: US 2023/0267542 A1
(43) Pub. Date: Aug. 24, 2023

(54) SYSTEM AND METHOD FOR ANALYSING FINANCIAL PRODUCTS

(71) Applicant: CONTRENDIAN LIMITED, Hong Kong (HK)

(72) Inventors: Frank Yiu Tung HO, Hong Kong (HK); Koon Wai CHEUNG, Hong Kong (HK)

(21) Appl. No.: 18/005,202

(22) PCT Filed: Oct. 23, 2020
(86) PCT No.: PCT/CN2020/123153

§ 371 Date: Jan. 12, 2023

(51) Int. Cl. G06Q 40/06

(52) U.S. Cl. CPC G06Q 40/06

(57) ABSTRACT

A method for analysing a financial product comprising the steps of: receiving an established portfolio of a user and obtaining a first performance characteristic of the established portfolio; receiving a financial product and obtaining a second performance characteristic of the financial product; comparing the first performance characteristic with the second performance characteristic to determine a diversity rating of the financial product with respect to the established portfolio, wherein the diversity rating is arranged to represent a rating of the diversification of the established portfolio if the portfolio was to include the financial product.

### TECHNICAL FIELD

The present invention relates to a system and method for analysing financial products, and particularly, although not exclusively, to a system and method for analysing financial products with respect to the financial product being suitable for the diversification of an investment portfolio.

### BACKGROUND

Investments are a way in which individuals can create savings and wealth for the future. Individuals wanting to invest have the choice of adopting various financial instruments to create wealth over time.

Despite the various financial instruments available, there are significant difficulties in the investment process as each financial instrument carries its own specific risk. These risks may render a specific financial instrument or investment strategy unsuitable for specific investors. In turn, investors may experience non-optimized returns, unjustified exposure to risk and other problems which will reduce the effectiveness of the investments in creating wealth.

The use of investment optimization technologies and the availability of information have helped investors make better investment decisions. However, much of these technologies are complicated and thus resulting in their adoption difficult for most investors. Less complex investment technology options which have been created to assist investors to understand their investment decisions better are helpful, but these options may also be too simplistic for an individual investor to optimize their return.

### SUMMARY OF THE INVENTION

In accordance with a first aspect of the present invention, there is provided a method for analysing a financial product comprising the steps of:
-receiving an established portfolio of a user and obtaining a first performance characteristic of the established portfolio;
-receiving a financial product and obtaining a second performance characteristic of the financial product;
-comparing the first performance characteristic with the second performance characteristic to determine a diversity rating of the financial product with respect to the established portfolio, wherein the diversity rating is arranged to represent a rating of the diversification of the established portfolio if the portfolio was to include the financial product.

In an embodiment of the first aspect, the step of comparing the first performance characteristic with the second performance characteristic to determine a diversity rating includes identifying correlating relationships between the first performance characteristics and the second performance characteristics.

In an embodiment of the first aspect, the correlating relationships are identified over a predetermined time period.

In an embodiment of the first aspect, the correlating relationships are further processed to determine the diversity rating.

In an embodiment of the first aspect, the diversification rating is determined for each of a plurality of financial products with respect to its inclusion into the portfolio.

6. A method for analysing a financial product in accordance with claim 5, wherein the diversification rating is determined for a combination of one or more of the plurality of financial products with respect to inclusion of the combination of one or more of the plurality of financial products into the portfolio.

In an embodiment of the first aspect, the first performance characteristic of the established portfolio is determined based on processing performance data of the established portfolio.

In an embodiment of the first aspect, the step of processing the performance data includes processing performance data of each asset of the established portfolio.

In an embodiment of the first aspect, the second performance characteristic of the financial product is determined based on processing performance data of the financial product.

In an embodiment of the first aspect, the method further comprises the step of obtaining a factor rating for the financial product, wherein the factor rating represents a general performance or suitability of the financial product.

In an embodiment of the first aspect, the factor rating is determined based on attributes of the financial product.

In an embodiment of the first aspect, the factor rating is determined by:
technical analysis of any technical attributes of the financial product; or,
fundamental analysis of any fundamental attributes of the financial product;
or any combination thereof.

In an embodiment of the first aspect, the diversity rating and the factor rating is visually presented on a matrix.

In an embodiment of the first aspect, the method further comprises the step of modelling a predicted optimized portfolio by including the one or more financial products into the investment portfolio and optimizing the investment portfolio.

In an embodiment of the first aspect, the predicted optimized portfolio is presented on a graph.

In accordance with a second aspect of the present invention, there is provided a system for analysing a financial product comprising:
-an investor gateway arranged to receive an established portfolio of a user and obtaining a first performance characteristic of the established portfolio;
-a product gateway arranged to receive a financial product and obtaining a second performance characteristic of the financial product; and
-a diversification processor arranged to compare the first performance characteristic with the second performance characteristic to determine a diversity rating of the financial product with respect to the established portfolio, wherein the diversity rating is arranged to represent a rating of the diversification of the established portfolio if the portfolio was to include the financial product.

In an embodiment of the second aspect, the diversification processor is arranged to process the first performance characteristic with the second performance characteristic to determine a diversity rating includes identifying correlating relationships between the first performance characteristics and the second performance characteristics.

In an embodiment of the second aspect, the correlating relationships are identified over a predetermined time period.

In an embodiment of the second aspect, the correlating relationships are further processed to determine the diversity rating.

In an embodiment of the second aspect, the diversification rating is determined for each of a plurality of financial products with respect to its inclusion into the portfolio.

In an embodiment of the second aspect, the diversification rating is determined for a combination of one or more of the plurality of financial products with respect to the inclusion of the combination of one or more of the plurality of financial products into the portfolio.

In an embodiment of the second aspect, the first performance characteristic of the established portfolio is determined based on processing performance data of the established portfolio.

In an embodiment of the second aspect, the processing of the performance data of the established portfolio includes processing performance data of each asset of the established portfolio.

In an embodiment of the second aspect, the second performance characteristic of the financial product is determined based on processing performance data of the financial product.

In an embodiment of the second aspect, the system further obtains a factor rating and is arranged to represent a general performance of the financial product.

In an embodiment of the second aspect, the factor rating is determined based on attributes of the financial product.

In an embodiment of the second aspect, the factor rating is determined by:
technical analysis of any technical attributes of the financial product; or,
fundamental analysis of any fundamental attributes of the financial product;
or any combination thereof.

In an embodiment of the second aspect, the diversity rating and the factor rating is visually presented on a matrix.

In an embodiment of the second aspect, the system further comprises a modelling processor arranged to model a predicted optimized portfolio by including the one or more financial products into the investment portfolio and optimizing the investment portfolio.

In an embodiment of the second aspect, the predicted optimized portfolio is presented on a graph.

In accordance with a third aspect of the present invention, there is provided an investment platform for analysing new financial products comprising:
an investor gateway arranged to obtain investment portfolio information from an investor,
an supplier gateway arranged to obtain new financial products from one or more financial products supplier,
a diversification processor arranged to process the new financial products and the investment portfolio to determine a diversification score of the financial products, wherein the diversification score represents a level of risk distribution of the investment portfolio when the financial product is included in the investment portfolio.

In an embodiment of the third aspect, the platform further includes an analysis processor arranged to obtain or determine a factor score of the financial product, wherein the factor score is arranged to represent the performance of the financial product relative to other financial products and is obtained or determined by performing a technical analysis or fundamental analysis of attributes of the financial product.

In an embodiment of the third aspect, the diversification score and factor score are visually represented in a matrix to the investor for each of the new financial products.

In an embodiment of the third aspect, the investor can select one or more of the new financial products for incorporation into their investment portfolio.

In an embodiment of the third aspect, the investment portfolio may be optimized.

In a fourth aspect of the present invention, there is provided an investment platform for analysing new financial products for investors comprising:
an investor gateway arranged to obtain investment portfolio information from an investor, wherein the investment portfolio is an existing established portfolio of the investor having a plurality of assets;
a supplier gateway arranged to obtain new financial products from one or more financial products supplier,
a diversification processor arranged to process the new financial products and the investment portfolio to determine a diversification score of the financial products, wherein the diversification score represents a level of risk distribution of the investment portfolio when the financial product is included in the investment portfolio; and
wherein the diversification processor is arranged to determine or obtain:
a performance variable of the investment portfolio over a defined period of time;
a performance variable of the one or more new financial products over the defined period of time; and
using the performance variable of the investment portfolio and the performance variable of the one or more new financial products, calculating a correlation variable between the performance variable of the investment portfolio and the one or more new financial products over the defined period of time, with the correlation variable being of a value between -1 and 1; and
processing the correlation variable into a real number value representative of the performance of the new financial product to diversify the risk of the investment portfolio, with a higher value representing a stronger level of diversification of risk;
an analysis processor arranged to obtain or determine a factor score of the financial product, wherein the factor score is arranged to represent the performance of the financial product relative to other financial products and is obtained or determined by performing a technical analysis or fundamental analysis of attributes of the financial product;
a user interface arranged to visually present a matrix to the investor the diversification score and factor score for each of the new financial products; and wherein the user interface includes a user manipulation function for the investor to select one or more of the new financial products for incorporation into their investment portfolio; and
   wherein the user interface is arranged to instruct the diversification processor and the analysis processor to recalculate the diversification score and factor score for each of the non selected new financial products upon the user selection of the one or more of the new financial products on the user interface, and the user interface is updated with the new diversification score and factor score for each of the non selected new financial products.

### BRIEF DESCRIPTION OF THE DRAWINGS

Embodiments of the present invention will now be described, by way of example, with reference to the accompanying drawings in which:

FIG. 1 is a schematic diagram of a computer server or computing system arranged to be implemented to operate as a system for analysing financial products in accordance with one embodiment of the present invention;

FIG. 2 is a block diagram of a method for analysing financial products arranged to be partially or wholly implemented to operate on a computing system of FIG. 1;

FIG. 3 is a block diagram illustrating another example embodiment of a system for analysing financial products;

FIG. 4A is a block diagram illustrating the process in which two investor portfolios and new financial products (assets) are processed by another example embodiment of a system for analysing financial products;

FIG. 4B is an example interface having an example matrix whereby assets of a current portfolio and one or more new financial products may be plotted on the matrix based on their diversity rating or score and factor rating or score.

FIG. 5A is a screenshot of an example interface shown to a user of an example of the system of FIG. 3.

FIG. 5AI is another screenshot of an example interface shown to a user of an example of the system of FIG. 3.

FIG. 5AV is another screenshot of an example interface shown to a user of an example of the system of FIG. 3.

FIG. 5AT is another screenshot of an example interface shown to a user of an example of the system of FIG. 3.

FIG. 5B is process flow diagram of an example interface shown to a user of an example of system of FIG. 3.

FIG. 5C is another screenshot of an example interface shown to a user of an example of the system of FIG. 3.

### DETAILED DESCRIPTION OF THE PREFERRED EMBODIMENT

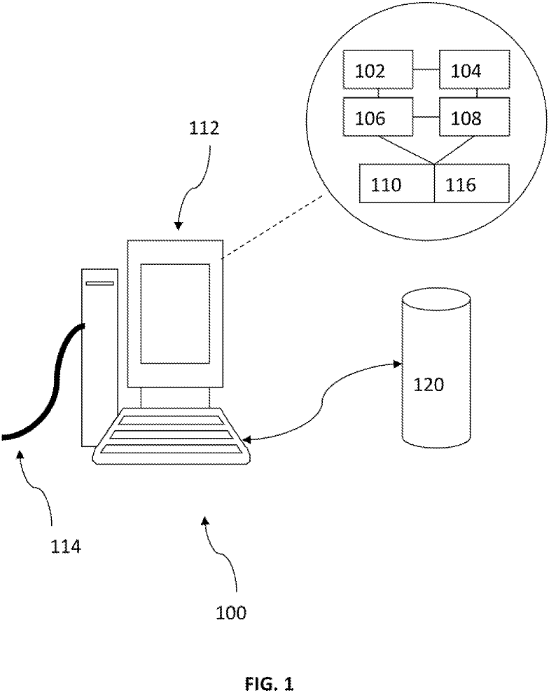

Referring to FIG. 1, an embodiment of the present invention is illustrated. This embodiment is arranged to provide a system and method for analysing financial products and comprises a computer or computing system which has an interface or gateway to communicate with users or financial institutions to obtain user data and any associated investments or investments portfolio that the user may already have or be interested in holding, and a diversification processor, which is arranged to process the received investment portfolio and financial products, perform an analysis of the characteristics of the investment portfolio and the financial product and determine an indicator, rating or score arranged to represent the diversification of the investment portfolio if the financial product is to be incorporated into the investment portfolio. In turn, in this embodiment of the system for analysing financial products, a user of the system may therefore be able to analyse how a new financial product of interest, may alter or change the characteristics of their existing investment portfolio so as to formulate an informed decision about the financial product with respect to their present investments.

In this example embodiment, the gateways or interfaces and processors are implemented by a computer, computing device or computer system having an appropriate user interface, processor and communication gateway. The computer or computing device may be implemented by any computing architecture, including stand-alone Personal Computers or computer server, client/server architecture, “dumb” terminal/mainframe architecture, cloud based computing architecture, portable computing devices including Internet of Things (IoT) devices or any other appropriate architecture. The computing device may be appropriately programmed to implement the invention.

Referring to FIG. 1, there is shown a schematic diagram of a computing system which may be implemented to operate as a system for analysing financial products. In this embodiment, the system is implemented on a computing device, such as a computer server 100 which may communicate with other information servers or data sources to obtain investment portfolio information or financial product information. The server 100 may also be in communication with users via an interface such as a web service or by connecting to a user’s computing or smart devices (e.g. portable electronic or computing devices such as smartphones, smart glasses, smart appliances, Internet of Things (IOT) devices, etc.) via software such as “apps” or Internet browsers.

In this example, the server 100 comprises suitable components necessary to receive, store and execute appropriate computer instructions. The components may include a processing unit 102, read-only memory (ROM) 104, random access memory (RAM) 106 and input/output devices such as disk drives 108, input devices 110 such as an Ethernet port, a USB port, etc. Display 112 such as a liquid crystal display, a light emitting display, remote displays or any other suitable display and communications links 114 may also be included. The server 100 includes instructions that may be included in ROM 104, RAM 106 or disk drives 108 and may be executed by the processing unit 102. There may also be provided a plurality of communication links 114 which may variously connect to one or more computing devices such as a server, personal computers, terminals, wireless or handheld computing devices, smart devices, IoT devices, portable computing devices or to any other devices via a network or cloud based computing system. At least one of a plurality of communications link 114 may be connected to an external computing network through a telephone line or other type of communications link.

The server 100 may include storage devices such as a disk drive 108 which may encompass solid state drives, hard disk drives, optical drives or magnetic tape drives. The server 100 may use a single disk drive or multiple disk drives. The server 100 may also have a suitable operating system 116 which resides on the disk drive or in the ROM of the server 100.

The server 100 may be executing software which has been implemented to provide a method for analysing financial products. When instructed by a user, the server 100 may then proceed to connect with the user and exchange various user related information including user identity and information relating to the user’s existing investments. The server 100 may then perform an analysis of the characteristics of these investments and formulate a profile which would model the performance of the investments held by the user. This profile may include, for example and without limitations, the historical performance (return) and risk of the investments.

Once this profile is created from the analysis, a similar analysis, if necessary, may be performed for other new financial products not presently part of the investments held by the user. When a profile for these new financial products are created, a comparison can then be compared with the investments held by the user to determine their suitability for inclusion in the investment portfolio already held by the user. Preferably, the level of suitability may include, for example, the diversification of the user’s existing investments so as to assist the user in knowing whether to adopt the new financial product as part of their investments in order to diversify their investments. In turn, by assisting a user in creating a diversified investment portfolio, the system may be advantageous for long term investors who would desire a particular expected return for a specific risk profile over a pre-determined period of time.

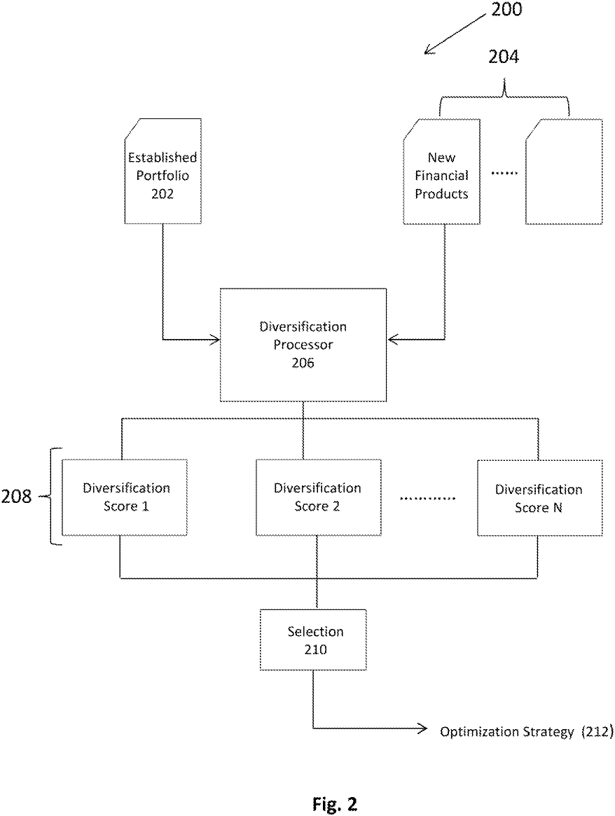

With reference to FIG. 2, there is illustrated a block diagram of an example system for analysing a financial product 200 comprising:
-an investor gateway arranged to receive an established portfolio of a user and obtaining a first performance characteristic of the established portfolio;
-a product gateway arranged to receive a financial product and obtaining a second performance characteristic of the financial product; and
-a diversification processor arranged to compare the first performance characteristic with the second performance characteristic to determine a diversity rating of the financial product with respect to the established portfolio, wherein the diversity rating is arranged to represent a rating of the diversification of the established portfolio if the portfolio was to include the financial product.

In this example, the system 200 includes a diversification processor 206 which uses an investor gateway and/or product gateway to communicate with investors and/or their investment representatives (e.g. financial institutions etc.) and a financial product supplier (e.g. a financial institution that offers financial products for investors). The communication may be initiated on request from a user, who may be an investor interested in using the system 200 to identify if there are any specific new financial products that may be used or otherwise adopted to improve their existing established investment portfolio. It should be understood that the term “established portfolio” or “established investment portfolio”, does not necessarily need to be limited to investment portfolios that have already been purchased and held, but may include portfolios that are being planned, studied or even hypothetically created based on real and traded assets and/or artificial or hypothetical assets, securities or other instruments.

Once a user initiates this request, the diversification processor 206 may firstly obtain information regarding the user’s existing investment portfolio 202. This may take the form of a user providing details of their existing investment portfolio 202, including which financial instruments or assets are held in the portfolio, or alternatively, by providing identification references to the system 200 which would allow the system 200 to query the user’s investment portfolio 202 via the user’s investment manager or financial institutions. Such information may include, without limitations, the type of assets (currencies, bonds, properties, funds, stock or derivatives etc.) held in the portfolio 202 as well as their amounts and any encumbrances, limitations, options or contracts that are associated with these assets.

After information relating to the user’s investment portfolio 202 is obtained, the information is then processed to identify various characteristics of the user’s investment portfolio for the purposes of identifying any diversification potential. Preferably, in the theory of portfolio management, a group of assets which form an investment portfolio may be optimized in various ways so as to obtain an optimal expected return against the risk that the portfolio 202 may experience over a pre-determined period of time, as predicted based on an analysis of available data, including historical data. As an example, in Modern Portfolio Theory (MPT), a selection of assets may be selectively held in various volumes or proportion to form a portfolio such that the portfolio may be optimized by adjusting the volumes or proportion of each of the assets as based on a model of the risks of each of the assets of the portfolio and their respective performance correlations against each other or against a specific index or benchmark. In turn, by following such an optimization process, the volumes of the assets may be adjusted according to their recorded performance characteristics such as their expected return, volatility or risk, or, the performance correlation with each other or certain indexes. Additional factors, such as possible trade volumes, transaction costs, foreign exchange risks, tax implications and legal limitations may also be considered in these adjustments.

In this example, the diversification processor 206 may have access to all of such information for a user’s investment portfolio 202 and may be able to perform an optimization analysis on the portfolio 202 of assets immediately based on a preferred optimization model at that time. During this time, the user may have also selected one or more financial products 204 for consideration or assessment for inclusion into their investment portfolio 202. Preferably, these new financial products 204 may include assets which are not at present within the investment portfolio 202 held by the user.

In order to determine the suitability of these new assets 204, a user may assess whether the new assets can improve or further optimize their existing investment portfolio 202, and if so, at what rate would these assets improve or further optimize their existing investment portfolio when compared with other new assets. In this regard, a possible strategy available to investors is to diversify their investment portfolio such that their exposure to risk may be better managed by spreading the risk over various assets that perform with some level of correlation (or negative correlation as the case may be in some examples) such that should any one of their assets in their portfolio perform poorly, than an asset of historical negative correlation to that asset may perform well over the same period to offset the poor performance.

In this example, the diversification processor 206 may obtain any available data which would represent the performance characteristics of each of the new assets, including its historical performance indicators such as previous returns and volatility, whilst calculating the asset’s correlating performance against the investment portfolio’s performance. This may require a comparison of the various indexes or the performance of the entire investment portfolio to determine a correlation between the new financial product and the investment portfolio. In some examples, the correlation is calculated between each of the new assets and the user’s existing investment portfolio as it exists, as the portfolio itself may have performance data over a period of time, or the performance of the portfolio can be recreated by processing the performance data of each of the assets which make up the portfolio to determine the performance of the portfolio over a period of time.

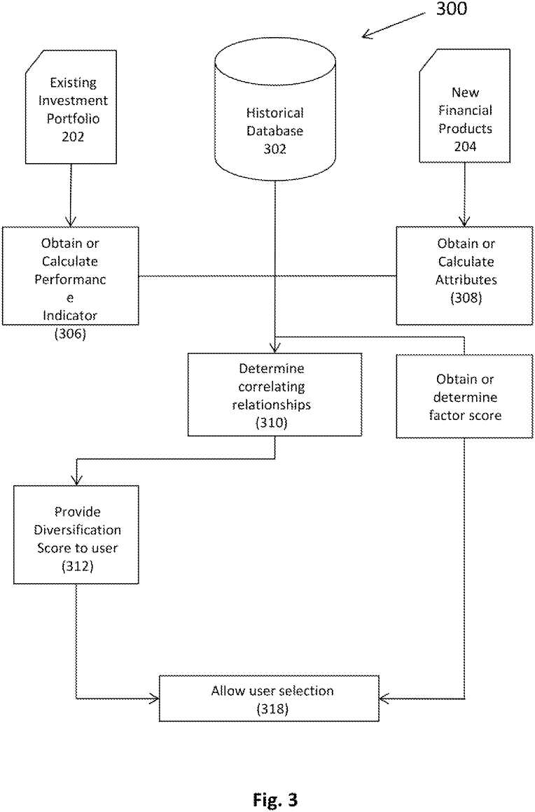

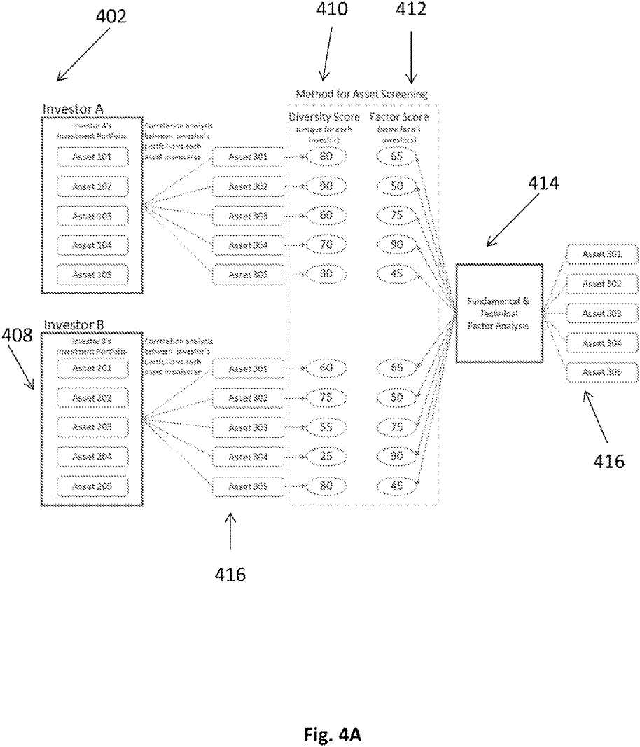

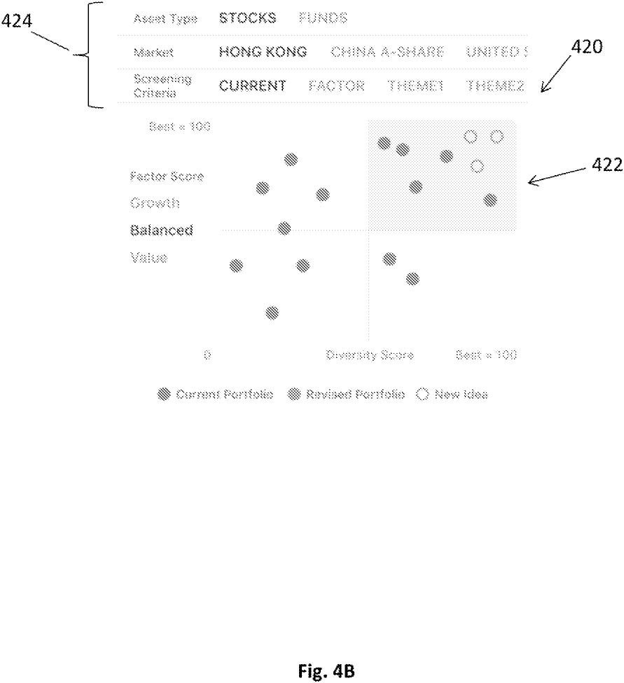

In turn, such a correlation calculating process can be repeated for each new asset under consideration until a diversification rating or score for each new asset is determined. Once a diversification score or rating is determined, the score or rating will then be provided to the user for consideration. In most preferred implementations, a higher score or rating would represent a superior diversification effect of the financial product, which would in turn suggest that the asset is more suitable for inclusion by the user in their investment portfolio. However, the purchase of each financial product may nonetheless be determined on personal, legal, tax or other performance preferences the user may have, or in preferred examples, a factor score, which measures objectively the general performance and suitability of that product as an investment vehicle. The factor score will be further described below with reference to FIGS. 3, 4A and 4B.

Embodiments of the system 200 may be advantageous as investors who use the system 200 may be able to provide details of their own investment portfolio which would be unique to them. This unique investment portfolio can be assessed with a new financial product to determine if it may assist the investor in diversifying their investments and to optimize their investment’s performance. In turn, each financial product would have a different suitability for each investor and thus investors can benefit in the sense that the system is able to provide the best product for them individually, whilst also allowing financial product suppliers to sell their products directly to investors that could most benefit.

In preferred embodiments of the system for analysing a financial product 200, which will be descripted in further detail below with reference to FIGS. 3, 4A and 4B, the system 200 may then proceed to provide factor scores for each of the financial products in addition to the diversification score determined earlier. The factor scores would represent the general characteristics of the financial product itself and may include a combination of fundamental factors, technical factors, historical performance, transaction costs, jurisdiction limitations, liquidity, foreign exchange risks, tax implications, forecasted market relevance or any other asset evaluation metrics which may provide an indicator to the overall characteristics of the financial product as an investment vehicle.

In another example, the diversification processor 206 may also proceed to use a modelling function or modelling processor to model the inclusion of the selected new asset within the existing investment portfolio held by a user and attempt to optimize such a portfolio to determine a diversification position that could then be compared to the optimized investment portfolio without the selected new asset. In these examples, the user may provide an estimated amount of money as a percentage of the investment portfolio for investment into this new asset which would therefore allow the diversification processor 206 to model the inclusion of the new asset and perform an optimization. With this modelling, a diversification score can also be determined to reflect whether the inclusion of the new asset would improve the performance of the investment portfolio.

The diversification processor 206 may also be arranged to perform a correlation analysis to determine a diversification score based on a combination of new assets. In this regard, more than one asset may be purchased by the user to further diversify their portfolio. In order to perform this analysis, the diversification processor 206 may model a portfolio of new assets which would be created by a combination of new assets that an investor may be able to invest in. This portfolio of new assets may in turn have its own performance data which can be used to calculate a diversification rating by considering the correlation of the performance data with the performance of the investor’s existing portfolio.

With reference to FIG. 3, there is provided a block diagram of another embodiment of a system for analysing financial products 300. In this embodiment, the system is arranged to operate on a server connected to the internet so that users may connect to the server to perform an analysis of financial products with their personal computing devices, such as desktop or laptop computers, tablet computers, smart phones or smart glasses or any other connected communication and computing devices.

As shown, the system may be connected to a historical records database 302 which will include available and historical performance data for different types of financial products as recorded over time. The database 302 need not be within the server of the system 300, but may be connected to the system 300 and accessible when necessary. It is anticipated that there may be numerous data sources and thus the term “database” 302 includes any one or more data sources that could be accessible to the system 300.

In this example, the system 300 may firstly receive a request from a financial product supplier, such as a bank, an investment organisation, fund manager or a fund raising specialist to place their financial products onto the system for offering to investors. In this regard, these parties may communicate with the system and offer their new financial products 204 for the system to offer to its investor users. In some instances, attributes of these new financial products 204, including performance indicators or price data (308) may be supplied by the financial product supplier, or they may be calculated or validated by the system 300 with the available historical data 302.

The system 300 may also be arranged to communicate with its investor users who may want to use the ability of the system 300 to optimize or further improve their investment portfolio by incorporating new financial products into the portfolio. In this regard, the user may first provide their existing investment portfolio 202 details to the system 300. This may be performed by logging into the system 300 with their user identification details after which the system 300 will be able to retrieve their investment portfolio either internally or via external means after authentication with other financial institutions. The details of the investment portfolio 202, may include, for example, the identification or codes of each of the assets which are in the portfolio.

Once the details of the investment portfolio 202 are obtained, the system 300 may then proceed to obtain or calculate the attributes of the portfolio, including any price or performance indicators (306) of the investment portfolio for subsequent processing to determine a diversification score for a new financial product relative to the investment portfolio 202. This may be performed in one example, by calculating or, if already known, obtaining the existing performance indicators of the investment portfolio. These performance indicators may be available for the entire investment portfolio, particularly in cases where the investment portfolio was created to track a specific index or is made of a group of commonly available assets. In certain situations where the investment portfolio is more unique and incorporates different classes of assets, it may be calculated based on available data of each of the assets that make up the investment portfolio. In situations where the information available does not allow accurate performance indicators for the investment portfolio to be created, then any necessary performance indicators may be best determined either by further calculation or using substitute performance data for individual assets of the portfolio.

The user may then proceed to select one or more new financial products 204 which are of interest for incorporating into their investment portfolio 202. This selection may be due to the user showing interest in a particular asset or perhaps the asset has been suggested for advertisement (pushed) to the user. In these cases, the user’s intention is likely to want to know how the new financial product will affect his or her present investment position and thus one manner in which this can be informed to the user is to calculate the diversification rating or score. This diversification rating or score would represent how a particular new financial product, if it was to be included into the user’s investment portfolio, would diversify the portfolio. The diversification of the portfolio is generally understood to be the distribution of risk of the portfolio over a period of time, as based on historical data of the performance of the assets of the portfolio and a calculated expected rate of return as based on this historical data.

Once the performance indicators for both the investment portfolio 202 and the new financial product 204 are obtained, the diversification score may then be determined by analysing the correlating relationships between the performance indicators of the investment portfolio 202 and the performance indicators of financial product 204. This may be performed by identifying correlations between the indicators by using statistical analysis of the performance of the investment portfolio 202 and the performance of the financial product 204. In turn, a score which represents the correlation between the two items may be determined.

In some examples, this correlation, in its raw form may range from strong correlation (1), no correlation (0) or negative correlation (-1). In turn, such a result may then be adapted for the user as a diversification rating, preferably by use of a numerical score which would be higher if there is a strong level of diversification should the new financial product be included, similarly, in this same example, a lower score may represent less diversification. This adaption may be performed by calculating the change in price (value) historically of the investment portfolio against the change in price historically of any new asset over a specific time period by use of statistical analysis to determine the correlation, if any, between the portfolio and the new asset. In examples where there is a strong level of negative correlation, then the diversification score may increase as the new asset’s historical performance would indicate that it could absorb the price movements of the existing investment portfolio.

Once the diversification score is determined (310), the score is then provided to a user (312) for review. Preferably, a factor score (314) may also be provided to the user for each of the new financial products 204 so as to assist a user in making a more informed decision. The factor score (314) may be calculated based on a combination of fundamental factors, technical factors, historical performance or any other asset evaluation metrics in order to determine the performance or general suitability of the financial product 204 for investment.

Preferably, the factor score is determined based on attributes for the new financial product which would include: fundamental attributes suitable for fundamental analysis, technical attributes suitable for technical analysis and other attributes which can be considered to determine the viability or suitability of the asset for investment due to macroeconomic, political, geographical, social or scientific influences. Examples of these attributes include, without limitations:

### Fundamental Attributes

Price-to-Trailing Earnings
Price-to-Forward Earnings
Price-to-Book Value
Price-to-Sales
Price-to-Gross Cash Flow
Price-to-Free Cash Flow
Enterprise Value-to-EBITDA
Dividend Yield
Return on Equity
Return on Investing Capital
Capital Expenditures-to-Sales
R&D-to-Sales
Operating Profit Margin
Net Profit Margin
Change in Sales
Change in Operating Profit
Change in Operating Profit Margin

### Technical Attributes

Total Return
Volatility
Sharpe Ratio
Option Pricing
Beta, Delta, Gamma, Vega, etc. (over different time horizons)

### Other Attributes

Market Capitalization
Shares Outstanding
Industry Classification
Sector Classification
Region / Country Classification

Selected attributes may be used for fundamental and/or technical analysis to determine the factor score (314), which is in turn obtained or calculated by the system 300 and provided to the user along with the diversification score (312). In turn, when both the diversification score (312) and the factor score (314) are presented to the user, the user may be able to consider both scores in making a selection as to which financial assets may be suitable for incorporation into their portfolio (318).

Embodiments of the system for analysing financial products 200 or 300 may be advantageous in that by providing these factor scores of each of the analysed financial products together with the diversification score, a user may then be guided towards a more informed decision when attempting to improve their investment portfolio, either by diversification, choosing preferred financial products or a combination of both. When a factor score is provided, a user may accept that a particular financial product may not have the best diversification score out of a selection of available financial products which has been analysed with respect to the user’s investment portfolio, but nonetheless decide to include such a financial product into their investment portfolio based on a superior factor score of the particular financial product. The system may therefore allow a user to choose a product that has less diversification benefit, but nonetheless has been chosen for inclusion into the user’s investment portfolio based on its factor score. In turn, improving the decision making process for an investor.

In a similar manner, it is also advantageous that a user may deliberately choose a new financial product for inclusion into an investment portfolio which may individually have a lower than expected factor score but due to its higher diversification score, a user may nonetheless choose a financial product based on its ability to provide diversification benefits to the user’s existing investment portfolio.

One advantage that may be offered by embodiments of the system 200, 300 is that by presenting both a factor score or rating and a diversification score or rating simultaneously to a user. The user may be able to make a more informed choice as to whether to invest in a new financial product. Similarly, for financial product suppliers, financial products which have a low factor score and may otherwise be unattractive to general investors may be more attractive to specific investors with portfolios that may be diversified by their inclusion into their portfolio.

In some alternative embodiments, the system 300 may then also proceed to create models of an optimized portfolio for the user based on the incorporating of one or more of the new financial products 204, or for one or more of the new financial products 204 which has been selected for possible inclusion into their investment portfolio, or for the inclusion of a combination of one or more of the new financial products 204 into the user’s investment portfolio. These models may be created by calculating the various performance indicators of the investment portfolio after it has included the one or more new financial products 204. The calculations may include the composition weight of the assets in the portfolio, the value of the assets at a particular time and the determination of an expected return based on a simulation of the value of each of the assets of the portfolio as based on historical performance.

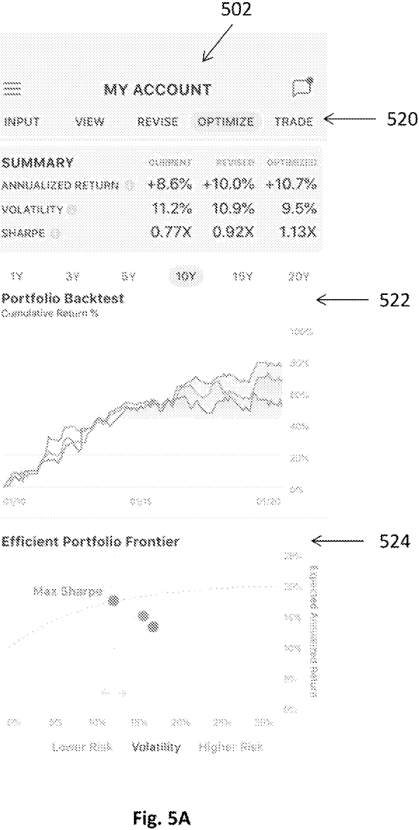

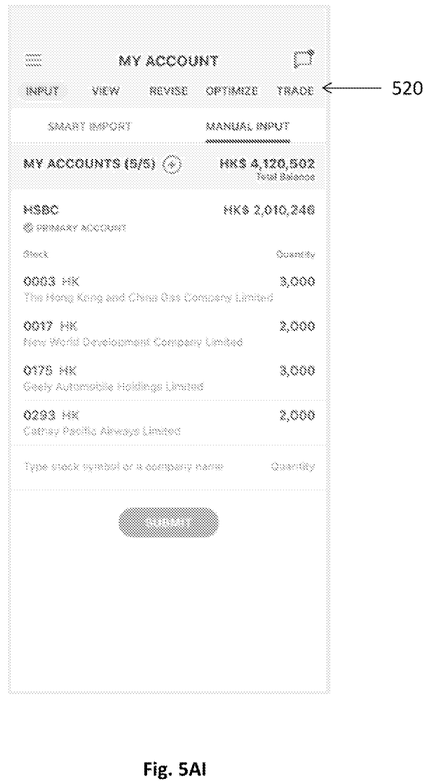

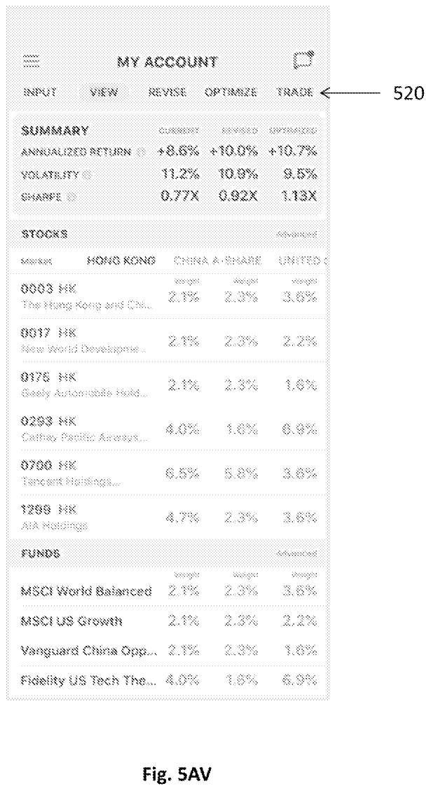

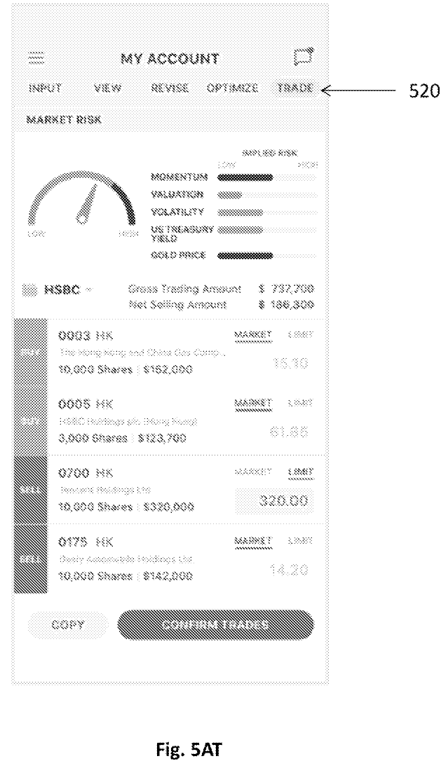

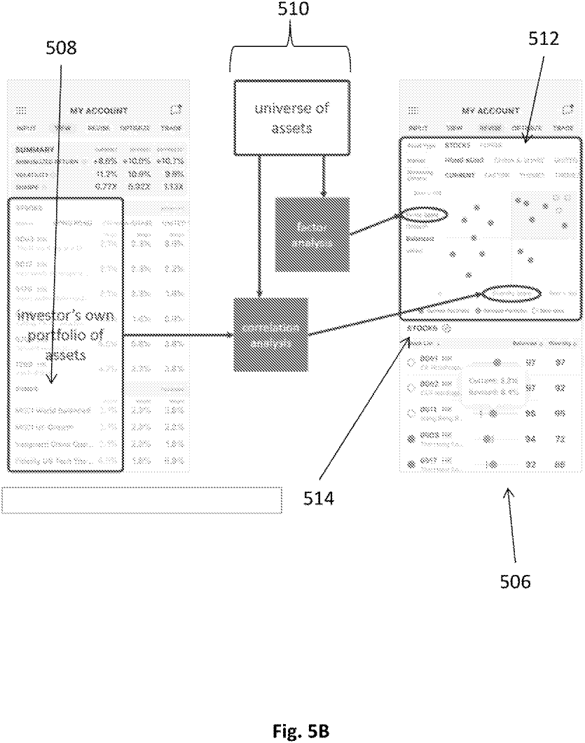

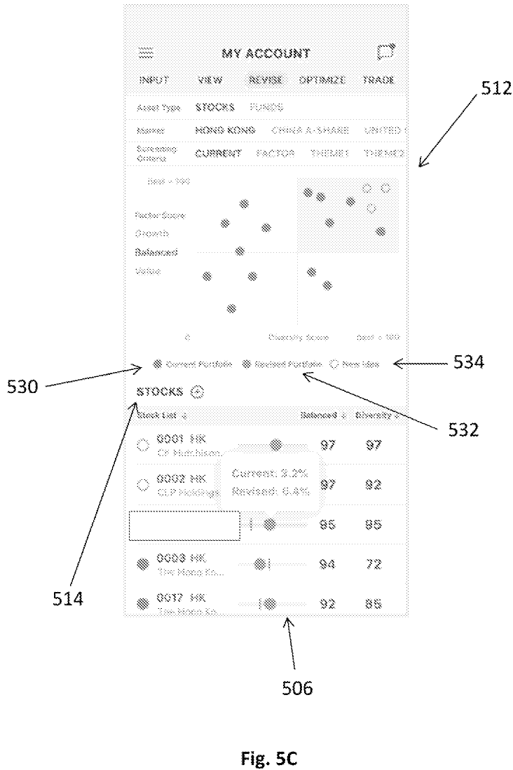

In turn, once the models are created, they may be presented to the user so as to allow the user to determine which of the investment portfolio models, corresponding to which of the new financial products 204 that have been incorporated into their investment portfolio 202, would be most ideal for the user in terms of value and potential earnings. These models may also be presented on an interface, such as those of FIG. 5A for the user to view the performance of their existing portfolio or a new portfolio having incorporated one or more new assets.

With reference to FIG. 4A, there is illustrated a flow diagram of two investor’s portfolio 402 and 408, being processed by an example of a system for analysing financial products. In this example, each investor’s portfolio belonging to investor A and investor B (402 and 408), will have their respective portfolio’s performance analysed for correlations with each of a plurality of new financial products 416 (asset 301, 302, 303, 304 and 305). The analysis of each of these assets 416 will result in a diversification score (or diversity score) 410 which as shown, would be dependent on the composition of the investor’s portfolio, and therefore would be unique for each investor’s portfolio. The diversification score 410, in turn allows each of the investors to determine how each of the assets would diversify their portfolio should they decide to include this asset into their portfolio.

Preferably, as shown in FIG. 4A, for each asset 416, a factor score is also determined by the system for analysing financial products to improve the decision making process by the user. The determination of the factor score, which in this instance uses fundamental and technical factor analysis of available attributes associated with the financial product 414, may be calculated by the system or obtained via various financial services or analysis sources. As it can be observed in FIG. 4A, the factor scores 412 are constant for all investor portfolios as the factor scores 412 relate to the asset itself. Thus when the diversity score 410 and the factor score 412 are provided to the user, the user can select the best asset for inclusion into their portfolio based on the consideration of both scores.

In this example embodiment, it is also preferred that the factor scores and the diversification scores may be presented to a user via a multi-dimension matrix 420 similar to the example as shown in FIG. 4B. In this example, the assets of the user’s current investment portfolio together with a plurality of new assets are each individually analysed by the diversification processor to determine a diversification score and a factor score as based on the methods that are described above. These scores are then used to plot each asset onto the matrix 420 as based on their diversification score and factor score.

As shown, the matrix 420 includes a horizontal axis which represented the diversification score and thus the further on the right, the superior the diversification would be in the new optimized investment portfolio, whilst the vertical axis represented the factor score of each of the financial products considered.

In this example of a matrix representation 420, the user can therefore visually inspect that the more superior financial products for adoption are likely found in the top right hand quadrant 422 of the matrix where the adoption of the financial products would diversify the portfolio and that the adopted financial product is of a superior factor score. The plotting of each asset, both current assets and new assets also allows the user to visually compare the quality of the new assets relative to their existing assets in their portfolio. In turn, a user may use this comparison to decide in removing existing assets from their portfolio in addition to adopting new assets. As shown, this matrix 420 may be generated for a range of securities of different asset types, in different markets, filtered by different screening criteria, or any other types of filtering mechanism 424 to provide the user with a more informed view of their investment portfolio.

Embodiments of the system for analysing financial products may be advantages as it is able to offer a service to investors to interpret how a new financial product could improve or impede their investment positions. Thus a user may be able to submit their investment portfolio to the system and provide one or more financial products of interest for assessment, or alternatively, the system provides a platform in which financial product providers, such as financial institutions, fund managers, product providers or any investment vehicle producer may offer their products to investors, whilst allowing investors an opportunity to independently assess the quality of the product for their investments.

With reference to FIGS. 5A to 5C, there is illustrated an example screenshots of an interface which may be presented to a user of the system for analysing a financial product. In this example, the system operates on a server, such as a cloud based server that is in connection with financial institutions and financial service providers. The server may then be arranged to communicate with a user via an “app” on their smartphone or tablet computer as shown which provides an interface for user’s to interact with the system, or alternatively, the communication with the server may be performed via an interface such as a website on a desktop computer of the user or their agents.

In this example, a user may access the system via an “app” on their smartphone, tablet computer and upon the provision of their identity, a user will be presented with a list of options in order to interact with the system so as to manage or otherwise manipulate their investment portfolio.

As shown in FIGS. 5A, 5AI, 5AV, 5AT, 5B and 5C, the interface provides a number of different functions for the user to access. These functions may be accessed by the user selecting one of a plurality of functional tabs 520. In this example, the functional tabs 520 include:

INPUT - The user can select this tab to input their account information, in turn allowing the system to retrieve their details, including details relating to their investment portfolio. An example interface of this function tab is illustrated in 5AI.

VIEW - The user may select this tab to view the composition of their portfolio, including three possible views where the user can see their current, revised or optimized portfolio as well as a summary of each portfolio. In this example, current portfolio refers to the user’s actual current investment positions based on the input account data, with a total weight of 100%. Revised portfolio is created as the user adds, removes or changes weights of stocks and funds. Changes may also be made under the Revise function tab as shown in FIG. 5C which are shown under the “revised” column. The information presented in the optimized portfolio column is created by optimizing the portfolio. This optimization procedure may be based on the use of Modern Portfolio Techniques so as to create a portfolio from the Efficient Portfolio Frontier. This effectively takes the revised portfolio and optimizes the weight combination for each position to achieve the best return / risk expectation. An example interface of this function tab is illustrated in 5AV.

REVISE - The user may select this tab to choose assets from the matrix 512 to add to the portfolio; the addition (and/or deletion) of assets then generates the revised portfolio. An example interface of this function tab is illustrated in FIG. 5C. This tab is further described below with reference to FIG. 5B and FIG. 5C.

OPTIMIZE - The user may select this tab so as to instruct the system to optimize the revised portfolio to generate the optimized portfolio. In order to perform this optimized procedure, the user selects one portfolio (i.e. one of the dots) from the efficient frontier as the preferred optimized portfolio; the backtest graph may also update automatically to reflect this. An example interface of this function tab is illustrated in 5A. This function tab is further described below with reference to FIG. 5A.

TRADE - The user may select this tab once the user is satisfied with the optimized portfolio as shown in FIG. 5A. The user may review all the rebalancing trades and commit the trades to the broker. An example interface of this function tab is illustrated in 5AT.

In this example, when a user logs in to the system with their account 502, a summary of their investment portfolio 508 may be retrieved from their financial institution or investment manager. Various details regarding their investments such as return, volatility or any other characteristics may be provided along with options to compare the performance of their portfolio against a theoretically optimized portfolio may also be provided as shown in FIG. 5AV.

The user may then select the different tabs 520 to view, analysis or manipulate their portfolio before committing to trade a particular asset. Additionally, the user’s investment portfolio 508 and its adoption of any new assets which are of interest may also be presented herein, with a “backtest” chart 522 to show the performance of the different portfolio options as well as an optimized (efficient portfolio frontier) view 524 of the portfolio options for the user to visualize the performance of any decisions they would make in changing the composition of assets in their portfolio. This is advantageous as users can quickly track the performance of their investment portfolio 508 against theoretical optimization models and determine if further adjustments of their portfolio are necessary.

In this implementation of the system, the user may also access various financial products 506 such as stocks, securities, derivatives, funds, currencies, bonds or any other financial product for consideration. These various financial products may be presented in a list 506 for the user’s consideration in the revise option tab as shown in FIGS. 5B and 5C. These financial products 506 may also be selected by a user, or it may be proposed to the user based on any specific advertisements placed with the system by financial product suppliers. The user may then observe updated information regarding each financial product and may proceed to trade or investigate these financial products as required.

With reference to FIG. 5B, the user may then proceed to select new financial instruments for adoption into their existing investment portfolio 508. As described above, the user’s own portfolio of assets 508 may then be processed by the diversification processor which will perform a correlation analysis of the new financial products to obtain a diversification score or rating 510. Similarly, the processor may also be arranged to perform a factor analysis of the new financial products to determine their performance characteristics or suitability for the user as represented by the factor score. This factor score is therefore produced along with the diversification score.

A matrix 512 similar to the example as described above with reference to FIG. 4B is used to present the investment portfolio’s position on the matrix without adoption of the new financial product, and with the adoption of one or combination of more than one new financial product. In turn, a user can observe the preferred financial products towards the top right quadrant of the matrix that would offer a superior diversification score and factor score to their existing investment portfolio. With the presentation of this information, users may not necessarily include the best assets for diversification, but one that may offer other advantages as demonstrated by the factor score or by other aspects such as transaction costs, liquidity, tax implications or other user personal preferences.

With reference to FIG. 5C, a larger screenshot of the revised function tab with a financial product selection portion is shown. As shown in this Figure, and also previously in FIG. 5B and FIG. 4A, the user is presented with a matrix 512 which may be populated by three types of assets. The first of these assets are those assets which are in the current portfolio of the user. These are referenced as “Current Portfolio” and are shown by the dark filled circles 530. The second of these assets are referred to as “revised portfolio” and are shown by lighter shaded (grey) circles 532 and finally, the third type of assets are represented by hollow rings 534, which are referred to as “new ideas”. These assets are effectively new financial products that may have been pushed or selected by a user for consideration in incorporating these assets into their investment portfolio.

As described above with reference to FIGS. 2 and 3, the placement of each asset into the matrix 512 may be performed by determining the diversification score relative to the performance of the user’s investment portfolio and the factor score, as determined by analysing the attributes of the financial product. In some examples, the process in populating the assets into the matrix 512 starts with determining the diversification score of each asset of the user’s investment portfolio relative to other assets of the user’s investment portfolio, followed by determining the factor score for each of these assets. After these scores are obtained, the circles for “current portfolio” 530 can then be plotted onto the matrix 512.

Following the placement of the “current portfolio” assets 530, the “new idea” assets 534, or the new financial products are then placed onto the matrix 512. This process may be performed by determining the diversification score of each of the new assets relative to the user’s investment portfolio, and obtaining the factor score for the specific new assets. Once placed onto the matrix 512, a user may be able to refer to each of the “new idea” circles 534 on the matrix 512 by manipulating each of the “new idea” circles 534 in the matrix 512. This may also present information as to the new asset selected. The user may also reference these new asset in a listing 506 presented adjacent to the matrix 512. User’s may also add additional assets of interest by selecting a “add stocks” button 514, which will prompt the user (not shown) to select new financial products from another listing or database, after which, the system may proceed to determine their diversity score and factor score, and plot each of these “new idea” circles 534 onto the matrix 512 for the user’s consideration.

In one example, when a user decided to select one of the new assets for inclusion into their investment portfolio, the user can press or manipulate any one of the “new idea” assets 534 on the matrix 512 and confirm their selection. After this action takes place, the “new idea” circle 534 becomes a “revised portfolio” circle 532 on the matrix 512, thus signalling their potential inclusion into the user’s investment portfolio. The user may select additional “new idea” assets 534 of interest, or may proceed to place a trade order on the “revised portfolio” assets 532 for inclusion into their portfolio via the interface as shown in FIG. 5AT. If the trade order is placed, the system is arranged to automatically adjust the user’s portfolio by buying the new asset so as to incorporate that asset into the portfolio. The amount that may be purchased may be determined by a pre-set preference, and may be financed by new funds, the reduction of existing assets (selling) or a combination of both.

In another embodiment, the matrix 512 may also be arranged to be refreshed on each manipulation by a user such that the positons of each asset as placed onto the matrix 512 is automatically recalculated upon each manipulation by the user. As indicated above, if a user selects a “new idea” circle 534 and thus turning that asset into a “revised portfolio” circle 532, the composition of the user’s investment portfolio may therefore change when the asset is finally incorporated into the investment portfolio. In this regard, it would also mean that once the portfolio has been updated, the diversity score for each of the assets, including the current portfolio assets, the revised portfolio assets and the new idea assets will change.

In order to accommodate this change, the system may proceed to perform the diversity score calculations again for all assets on the matrix upon each user’s manipulation of the “new idea” assets 534 that would turn the assets into a “revised portfolio” asset 532. One advantage of this example embodiment is that in certain situations where the number of assets held by a user in an investment portfolio is relatively small, or that there is a generally weak correlation relationship amongst the assets, then the introduction of a new asset may significantly change the diversity score of all of the assets and/or the portfolio and thus this recalculation may be provide a more updated matrix 512 for the user’s consideration, particularly when the user intends to incorporate a number of new assets into their portfolio successively or in a short amount of time.

Nonetheless, in examples where there is no recalculation of the diversity score upon each manipulation by a user, such examples may be advantageous as there is less usage of computational resource by the system. The recalculation of the diversity score upon each manipulation may be intensive in certain instances. Additionally, in investment portfolios which are already somewhat optimized, have a larger number of assets or already have some correlating relationship amongst the assets, the inclusion of one or a small number of new assets are unlikely to change the diversity score substantially. In turn, the refreshing of their positions on the matrix 512 is unlikely to be of much benefit in these instances. Accordingly, both examples may be implemented and selectively used based on computation resources and/or user portfolio types to improve the user experience, accuracy, computational speed or a combination thereof.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices, smart devices, smart phones, wearable devices, Internet of Things (IoT) devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1-36. (canceled)

37. A system for analysing a financial product comprising:
an investor gateway arranged to receive an established portfolio of a user and obtaining a first performance characteristic of the established portfolio;
a product gateway arranged to receive a financial product and obtaining a second performance characteristic of the financial product; and
a diversification processor arranged to compare the first performance characteristic with the second performance characteristic to determine a diversity rating of the financial product with respect to the established portfolio, wherein the diversity rating is arranged to represent a rating of the diversification of the established portfolio if the portfolio was to include the financial product.

38. The system for analysing a financial product in accordance with claim 37, wherein the diversification processor is arranged to process the first performance characteristic with the second performance characteristic to determine a diversity rating includes identifying correlating relationships between the first performance characteristics and the second performance characteristics.

39. The system for analysing a financial product in accordance with claim 38, wherein the correlating relationships are identified over a predetermined time period.

40. The system for analysing a financial product in accordance with claim 39, wherein the correlating relationships are further processed to determine the diversity rating.

41. The system for analysing a financial product in accordance with claim 40, wherein the diversification rating is determined for each of a plurality of financial products with respect to its inclusion into the portfolio.

42. The system for analysing a financial product in accordance with claim 41, wherein the diversification rating is determined for a combination of one or more of the plurality of financial products with respect to the inclusion of the combination of one or more of the plurality of financial products into the portfolio.

43. The system for analysing a financial product in accordance with claim 42, wherein the first performance characteristic of the established portfolio is determined based on processing performance data of the established portfolio.

44. The system for analysing a financial product in accordance with claim 43 wherein the processing of the performance data of the established portfolio includes processing performance data of each asset of the established portfolio.

45. The system for analysing a financial product in accordance with claim 44, wherein the second performance characteristic of the financial product is determined based on processing performance data of the financial product.

46. The system for analysing a financial product in accordance with claim 45, wherein a factor rating is obtained and is arranged to represent a general performance of the financial product.

47. The system for analysing a financial product in accordance with claim 46, wherein the factor rating is determined based on attributes of the financial product.

48. The system for analysing a financial product in accordance with claim 47 wherein the factor rating is determined by:
technical analysis of any technical attributes of the financial product; or,
fundamental analysis of any fundamental attributes of the financial product;
or any combination thereof.

49. The system for analysing a financial product in accordance with claim 48, wherein the diversity rating and the factor rating is visually presented on a matrix.

50. The system for analysing a financial product in accordance with claim 49, further comprising a modelling processor arranged to model a predicted optimized portfolio by including the one or more financial products into the investment portfolio and optimizing the investment portfolio.

51. The system for analysing a financial product in accordance with claim 50, wherein the predicted optimized portfolio is presented on a graph.

52. An investment platform for analysing new financial products comprising:
an investor gateway arranged to obtain investment portfolio information from an investor,
an supplier gateway arranged to obtain new financial products from one or more financial products supplier,
a diversification processor arranged to process the new financial products and the investment portfolio to determine a diversification score of the financial products, wherein the diversification score represents a level of risk distribution of the investment portfolio when the financial product is included in the investment portfolio.

53. The investment platform in accordance with claim 52, further including an analysis processor arranged to obtain or determine a factor score of the financial product, wherein the factor score is arranged to represent the performance of the financial product relative to other financial products and is obtained or determined by performing a technical analysis or fundamental analysis of attributes of the financial product.

54. The investment platform in accordance with claim 53, wherein the diversification score and factor score are visually represented in a matrix to the investor for each of the new financial products.

55. The investment platform in accordance with claim 54, wherein the investor can select one or more of the new financial products for incorporation into their investment portfolio.

56. The investment platform in accordance with claim 55, wherein the investment portfolio may be optimized.
